(19) United States
(12) Patent Application Publication
(10) Pub. No.: US 2015/0099036 A1
(43) Pub. Date: Apr. 9, 2015

(54) DAIRY BEVERAGE AND METHOD OF PREPARATION THEREOF

(71) Applicant: NESTEC S.A., Vevey (CH)

(72) Inventors: Pierre-Anton Aichinger, Gumligen (CH); Rafael Berrocal, Saint-Legier (CH); Pascal Volery, Bulle (CH)

(73) Assignee: NESTEC S.A., Vevey (CH)

(21) Appl. No.: 14/400,089

(22) PCT Filed: May 7, 2013
(86) PCT No.: PCT/EP13/59515

§ 371 Date: Nov. 10, 2014

(30) Foreign Application Priority Data
May 10, 2012 (EP) 12167441.0

(51) Int. Cl. A23C 9/13; A23L 1/29

(52) U.S. Cl. CPC A23C 9/1307; A23C 9/1315; A23L 1/296; A23V 2002/00
USPC 426/71; 426/580; 426/583; 426/72

(57) ABSTRACT

A shelf-stable beverage adapted for consumption by infants and young children is disclosed, as well as its manufacturing process. The beverage comprises milk, hydrolysed cereals, and fermented milk, in particular yogurt, and pectin. It may also comprise fruit.

### TECHNICAL FIELD

The invention relates to a milk and cereal beverage adapted for consumption by infants and young children, and its manufacturing process.

### BACKGROUND OF THE INVENTION

Any discussion of the prior art throughout the specification should in no way be considered as an admission that such prior art is widely known or forms part of common general knowledge in the field.

WO 03/086092 A1 (General Mills) relates to a method for the production of an acidified nutritionally fortified cultured dairy beverage or yogurt product. The method comprises preparing a non-fermented fluid dairy base, homogenizing and pasteurizing said base mix, adding a yogurt to said base mix, adding an acid blend to said base mix, comminuting said base mix to reduce particle size, adding a flavour and a colour to said base mix, and packaging to provide an acidified nutritionally fortified cultured dairy beverage composition containing live and active cultures, having a finished product culture count of at least 1.5×10e8 cfu/gram, a viscosity of 400 to 3500 cps at a temperature of 1° C. to 7° C. and a final pH of 3.8 to 4.5.

WO 00/47063 A2 (Natura Inc.) relates to a beverage comprising a blend of milk, fruit or vegetable juice and cereal grain/polysaccharide, for human consumption and methods of production thereof. The cereal is raw or processed cooked cereal, such as rice, corn and wheat. This beverage contains SUCRELESSE as a stabiliser. According to WO 00/47063 A2, SUCRELESSE is described in U.S. Pat. No. 5,766,636. SUCRELESSE helps maintaining the pH of the milk blend between 3.0 and 7.0. It is a mixture of amino acids, metal ions source, organic acids and inorganic acids. The beverage is stored in the refrigerator.

It is desirable to overcome or ameliorate at least one of the disadvantages of the prior art, or to provide a useful alternative. In particular, there remains a need to provide a beverage adapted to infants and young children, which contains ingredients recognized for their health benefits, and which is shelf-stable.

### SUMMARY OF THE INVENTION

To this end, there is now provided a beverage composition comprising a milk component, a hydrolysed cereal component, a fermented milk component, and added pectin, wherein the pH of the beverage composition ranges from pH 4.6 to 5.1, such as from pH 4.8 to 5.0, and the beverage composition is shelf-stable. In a particular embodiment, the beverage composition comprises a fruit component. In another embodiment, the fermented milk component is yogurt.

There is also provided a process for manufacturing a shelf-stable beverage composition, said process comprising the steps of: a) providing a first liquid mix, comprising a milk component and a hydrolysed cereal component, b) blending pectin into the first liquid mix, and maintaining the blend at a temperature ranging from 2° C. to 14° C., then c) incorporating a fermented milk component into the first liquid mix (containing the added pectin, that is to say the blend obtained from step b), also called the blend from step b)), to obtain a second liquid mix, d) adjusting the pH of the second liquid mix to a value ranging from pH 4.6 to 5.1, and e) heat-treating the second liquid mix to obtain a shelf-stable beverage composition.

These and other aspects, features and advantages of the invention will become apparent to those skilled in the art upon reading the disclosure provided here. The detailed description, while indicating particular embodiments of the invention, is only given by way of illustration.

### BRIEF DESCRIPTION OF THE FIGURES

FIG. 1. pH and viscosity index for a yogurt drink according to the invention containing peach purée. The figures illustrate the pH (circles) and the viscosity index (triangles) determined for a first batch (FIG. 1A) and a second batch (FIG. 1B) of a yogurt drink containing peach purée stored at ambient temperature (either at 20° C. or at 30° C.). According to the methods of measurement, the stability of the beverage composition is assessed by monitoring the pH (circles) and the viscosity index (triangles) as measured after 30, 90, 180, 270 and 360 days of storage at 20° C. (filled symbols) and at 30° C. (opened symbols) for the peach variety of the yogurt drink.

FIG. 2 pH and viscosity index for a yogurt drink according to the invention containing strawberry purée. The figures illustrate the pH (circles) and the viscosity index (triangles) determined for a first batch (FIG. 2A) and a second batch (FIG. 2B) of a yogurt drink containing strawberry purée stored at ambient temperature (either at 20° C. or at 30° C.). According to the methods of measurement, the stability of the beverage composition is assessed by monitoring the pH (circles) and the viscosity index (triangles) as measured after 30, 90, 180, 270 and 360 days of storage at 20° C. (filled symbols) and 30° C. (opened symbols) for the strawberry variety of the yogurt drink.

FIG. 3 pH and viscosity index determined for a yogurt drink according to the invention containing banana purée. The figure illustrates the pH (circles) and the viscosity index (triangles) determined for a yogurt drink containing banana purée stored at ambient temperature (either at 20° C. or at 30° C.). According to the methods of measurement, the stability of the beverage composition is assessed by monitoring the pH (circles) and the viscosity index (triangles) as measured after 30, 60, 90, 120, 150, 180, and 270 days of storage at ambient temperature at 20° C. (filled symbols) and 30° C. (opened symbols) for the banana variety of the yogurt drink.

### DETAILED DESCRIPTION OF THE INVENTION

Unless the context clearly requires otherwise, throughout the specification, the words “comprise”, “comprising” and the like are to be construed in an inclusive sense, that is to say, in the sense of “including, but not limited to”, as opposed to an exclusive or exhaustive sense.

As used in the specification, the singular forms “a”, “an”, and “the” include plural referents unless the context clearly dictates otherwise.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

The term “infant” means a child under the age of 12 months.

The term “young child” means a child aged between one and three years.

The term “infant formula” means a foodstuff intended for particular nutritional use by infants during the first months of life and satisfying by itself the nutritional requirements of such infants until the introduction of appropriate complementary feeding, as defined in European Commission Directive 2006/141/EC of 22 December 2006. The term “infant formula” includes hypoallergenic infant formulae. The term “follow-on formula” means a foodstuff intended for particular nutritional use by infants when appropriate complementary feeding is introduced and constituting the principal liquid element in a progressively diversified diet of such infants.

The term “growing-up milk” (GUM) means a foodstuff intended for particular nutritional use by young children. GUM generally ensures a steady transition from the lower protein level of breast milk to the high protein level present in cow's milk and normal dairy products used by adults.

It is noted that the various aspects, features, examples and embodiments described in the present application may be compatible and/or combined together.

The beverage composition of the present invention is particularly adapted for children, especially infants and young children, in terms of nutritional content and organoleptic properties such as taste, texture, or viscosity. In particular, the beverage composition according to the invention is a shelf-stable dairy beverage suitable for infants and young children.

In some embodiments, the beverage composition according to the invention may be adapted to infants' nutritional requirements only. In other embodiments, the beverage composition of the present invention may also be adapted to young children's nutritional requirements, or only to young children's nutritional requirements. In a particular embodiment, the beverage composition is ready-to-drink such as a yogurt drink also called a ready-to-drink yogurt. In other words, there is no need to heat, mix or otherwise prepare the beverage before it is consumed. The ready-to-drink beverage composition can be filled into an appropriate container and the composition can be consumed directly from the container, for instance with a straw or from an opening in the container. Alternatively, the ready-to-drink beverage composition can be poured from the container into a recipient, for instance a glass or a nursing bottle, for consumption. The beverage composition does not need to be squeezed out of its packaging prior to consumption. It can be poured into a glass or a feeding bottle for instance.

The beverage composition according to the invention comprises several components, including a milk component, a hydrolysed cereal component, added pectin, and a fermented milk component. A process for manufacturing the beverage composition is also described below.

The milk component of the beverage composition according to the invention is generally different from the fermented milk component. It is generally a non-fermented milk component.

The milk in the milk component and in the fermented milk component is, or derives from, cow milk, buffalo milk, yak milk, goat milk, ewe milk, mare milk, donkey milk, camel milk, reindeer milk, moose milk, or combinations thereof. In some embodiments, the milk in the milk component and in the fermented milk component is, or derives from, cow milk, goat milk, ewe milk, or combinations thereof. Particularly, it is, or derives from, cow milk. The term “derives from” in relation with the milk in the milk component and the fermented milk component is used to denote the fact that the milk component or the fermented milk component may contain or be prepared from various milks and milk constituents, such as fresh milk, milks with various fat contents, milk proteins only, such as in whey or milk protein preparations, as well as mixes of milk proteins and milk fats, and individual milk components or fractions such as lactose or minerals; milks having undergone various types of processing, such as homogenisation or heat treatment, such as UHT treatment or pasteurisation; and milk in various forms, such as liquid, concentrated, or dried (such as spray-dried or freeze-dried).

The milk component may be selected from skim milk, semi-skim milk, full-fat milk, follow-on formula or growing-up milk. Skim milk is a milk that contains less than 0.1% milk fat. Semi-skim milk is milk that contains between 1.5% and 2.5% milk fat. Usually, full-fat milk is milk that contains 3% to 4% fat. The exact fat content values for skim, semi-skim and full-fat milks depend mainly on local food regulation. In some advantageous embodiments, the milk component is skim milk, growing-up milk, or follow-on formula. In a particular embodiment, the milk component is follow-on formula.

In some embodiments, the milk component is in the form of milk powder, fresh milk or heat-treated milk. Advantageously, the milk component is or derives from skim milk, provided as milk powder, or fresh milk or heat-treated milk. Using skim milk allows better control of the fat content of the beverage composition.

Conventionally, the fermented milk component of the beverage composition of the present invention is obtained by controlled fermentation of milk. In the beverage composition, the fermented milk component provides specific benefits. In particular, the fermented milk component provides flavour and acidity to the beverage composition. It may also affect the texture of the beverage composition. In addition, micro-organisms employed in fermentation are selected for their capacity to ferment milk into a consumable fermented milk product. Usually, said micro-organisms are known for their beneficial properties. Said micro-organisms include lactic acid bacteria and yeasts. Some of these micro-organisms may be considered as probiotics. Examples of lactic acid bacteria include Lactobacillus delbrueckii subsp. bulgaricus and Streptococcus thermophilus (such as Streptococcus salivarius subsp. thermophilus), both of which are involved in production of yogurt, or other lactic acid bacteria belonging to the genera Lactobacillus, Streptococcus, Lactococcus, Leuconostoc, Bifidobacterium, Pediococcus or any mixture thereof.

Another example of fermented milk products, also known as cultured dairy products or cultured dairy foods, or cultured milks, is cultured buttermilk fermented with Lactococcus lactis (Lactococcus lactis subsp. lactis, Lactococcus lactis subsp. cremoris, Lactococcus lactis subsp. lactis biovar. diacetylactis) and/or Leuconostoc mesenteroides subsp. cremoris.

The micro-organisms may be live or inactivated.

In an embodiment, the fermented milk component is selected from yogurt, dahi, matsoni, cultured buttermilk or kefir. In a particular embodiment, the fermented milk component is yogurt. In a particular embodiment, the fermented milk component is provided as a powder, such as a spray-dried or freeze-dried powder. In a particular embodiment, the fermented milk component is yogurt powder.

In an embodiment, the milk component and the fermented milk component (“total milk components”) represent from 15% to 90% by weight (dry weight) of the total solids of the composition. In some particular embodiments, the total milk components represent from 20% to 80% by weight (dry weight) of the total solids of the composition. Thus, total milk components represent a major part of the beverage composition, and provide the nutritional value associated with milk and fermented milk. In a particular embodiment, the fermented milk component represents the equivalent of from 5 g to 90 g of fresh fermented milk per 100 g of composition, or a minimum of 10 g, or 15 g, or a minimum of 20 g of fresh fermented milk per 100 g of composition. The fermented milk component may also represent a maximum of 85 g, or 60 g, or a maximum of 35 g of fresh fermented milk per 100 g of composition. In a particular embodiment, the fermented milk component represents the equivalent of from 20 g to 35 g, or from 22 g to 30 g, of fresh fermented milk per 100 g of composition.

A further component of the beverage composition of the present invention is a hydrolysed cereal component. Methods of making a hydrolysed cereal product are known, for instance from EP 0031050 A2, or EP 0779038 A1. Advantageously, the hydrolysed cereal component is provided as a liquid hydrolysed cereal component. In other words, the process described in the two European patent applications mentioned above is followed without the drying step described in these two European patent applications. Of course, it is also possible to use a dried hydrolysed cereal component. In that case, an appropriate amount of water or fruit juice may be needed in order to reconstitute a liquid hydrolysed cereal component. When manufacturing the hydrolysed cereal component, cereal flour is mixed with water and amylolytic enzymes, in order to liquefy the cereal flour. The cereal can be wheat, rice, corn, oat, barley, or any mixtures thereof. In a particular embodiment, the cereal is wheat or rice. Rice does not contain gluten, which can be advantageous to manufacture a gluten-free beverage composition. Using a hydrolysed cereal component in the beverage composition has several advantages, such as permitting to include cereals at high levels without compromising the texture of the beverage composition, contributing to the overall sweetness, and making the cereals easier to digest.

In some particular embodiments, the hydrolysed cereal component represents from 10% to 65% by weight of the total solids of the composition, or from 22% to 30% by weight of the total solids of the composition, for example about 25% by weight of the total solids of the composition. Below 10% by weight, it may be difficult to provide the benefits of the cereal with a single serving. Above 65% by weight, the sensory profile of the beverage composition may become unsatisfactory for infants and young children.

The beverage composition of the present invention also comprises added pectin. Pectin is needed to improve the stability of the beverage composition. In particular, addition of pectin to the beverage composition helps reduce or prevent protein flocculation during heat-treatment at acidic pH. Pectin may also help reduce or prevent sedimentation in the beverage composition during storage. In addition, pectin contributes to the mouthfeel and viscosity of the beverage composition. Various types of pectins can be used in the present invention, and the skilled man will be able to identify any suitable pectins. The pectins may be defined by their degree of esterification (DE). Suitable pectins can be low-ester pectins (DE <50%), high-ester pectins (DE >50%) or a combination thereof. Preferably, pectins having appropriate functionality in acidic products are used. In a specific embodiment, the beverage composition of the present invention comprises low-ester pectins. In an advantageous embodiment, the beverage composition of the present invention comprises high-ester pectins. Pectins typically included in acidified milk drinks are high-ester pectins, such as pectins extracted from citrus peel, for example GENU® pectin type JMJ (supplied by CPKelco). Usually, it is recommended to use such high-ester pectins at low pH, for instance in the range of pH 3.7 to 4.4 as indicated for GENU® pectin type JMJ, to achieve the desired stabilising effect. Contrary to usual recommendations, the inventors have found that it is possible to use high-ester pectins at a pH ranging from 4.6 to pH 5.1. This is much higher than the recommended pH for protein stabilisation with such pectins, in the beverage composition.

In particular embodiments, the added pectin (such as GENU® pectin type JMJ) represents from 0.15% to 5.0% by weight of the total solids of the composition, or from 0.5% to 5.0% by weight of the total solids of the composition, or from 0.8% to 3.5% by weight of the total solids of the composition, or from 1.0% to 2.5% by weight of the total solids of the composition. Pectin may be provided as a powder, or as a solution or suspension in water.

In some particular embodiments, the beverage composition according to the invention may also comprise a fruit component as additional ingredient. The fruit component provides colour and flavour to the beverage composition. The fruit component can also provide fibres, as well as specific nutrients. The fruit component can be added in several forms such as fruit juice, with or without pulp, nectar, purée, concentrate, powder. In specific embodiments, the fruit component can be provided as a fruit purée or fruit juice. Fruit concentrate or fruit powder can also be reconstituted first in water or milk, before use. Fruits include, in particular: apple, apricot, banana, cherry, grape, mango, orange, peach, pear, pineapple, plum, raspberry, and strawberry.

The beverage composition of the present invention may also contain other additional ingredients, provided they are suitable for infant nutrition or young children nutrition, such as sweeteners, starches, flavour, prebiotics, vitamins, minerals or any combination thereof.

In an embodiment, the additional ingredients are added at any step prior step e), such as for example added in the first liquid mix during step a).

A prebiotic is a non-digestible food ingredient that beneficially affects the host by selectively stimulating the growth and/or activity of one or a limited number of species of bacteria in the colon, and thus improves host health. Such ingredients are non-digestible in the sense that they are not broken down and absorbed in the stomach or small intestine and thus pass intact to the colon where they are selectively fermented by the beneficial bacteria. Examples of prebiotics include certain oligosaccharides, such as fructooligosaccharides (FOS), galactooligosaccharides (GOS), BMOs (bovine milk oligosaccharides), HMOs (human milk oligosaccharides) and any mixture thereof.

A “galacto-oligosaccharide” is an oligosaccharide comprising two or more galactose molecules which has no charge and no N-acetyl residue

Suitable galacto-oligosaccharides include Galβ1,6Gal, Galβ1,6Galβ1,4G1c, Galβ1,6Galβ1,6Glc, Galβ1,3 Galβ1,3Glc, Galβ1,3Galβ1,4Glc, Galβ1,6Galβ1,6Galβ1,4Glc, Galβ1,6Galβ1,3Galβ1,4Glc, Galβ1,3Galβ1,6Galβ1,4Glc, Galβ1,3Galβ1,3Galβ1,4Glc, Galβ1,4Galβ1,4Glc and Galβ1,4Galβ1,4Galβ1,4Glc. Synthesised galacto-oligosaccharides such as Galβ1,6Galβ1,4Glc, Galβ1,6Galβ1,6Glc, Galβ1,3G alβ1,4Glc, Galβ1,6Galβ1, 6Galβ1,4Glc, Galβ1,6Galβ1,3Galβ1,4Glc and Galβ1,3Galβ1,6Galβ1,4Glc, Galβ1,4Galβ1,4Glc and Galβ1,4Galβ1,4Galβ1,4Glc and mixtures thereof are commercially available under the trade marks Vivinal ® and Elix′or ®. Other suppliers of oligosaccharides are Dextra Laboratories, Sigma-Aldrich Chemie GmbH and Kyowa Hakko Kogyo Co., Ltd. Alternatively, specific glycoslytransferases, such as galactosyltransferases may be used to produce neutral oligosaccharides.

In a particular embodiment there will be a combination of prebiotics consisting of 90% GOS with 10% short chain fructo-oligosaccharides such as the product sold under the trademark Raftilose® or 10% inulin such as the product sold under the trademark Raftiline®.

In some other embodiments of the invention the BMOs can be “CMOS-GOS”. This is a mixture of galacto-oligosaccharide(s), N-acetylated oligosaccharide(s) and sialylated oligosaccharide(s) in which the N-acetylated oligosaccharide(s) represents 0.5 to 4.0% of the oligosaccharide mixture, the galacto-oligosaccharide(s) represents 92.0 to 98.5% of the oligosaccharide mixture and the sialylated oligosaccharide(s) represents 1.0 to 4.0% of the oligosaccharide mixture.

The milk oligosaccharides can also be selected from the list comprising N-acetylated oligosaccharides, sialylated oligosaccharides, fucosylated oligosaccharides and any mixture thereof.

A “N-acetylated oligosaccharide” is an oligosaccharide having an N-acetyl residue.

Some examples of N-acetylated oligosaccharides include GalNAcα1,3Galβ1,4Glc and Galβ1,6GalNAcα1,3Galβ1,4Glc, LNT (lacto-N-tetraose) and LNnT (lacto-N-neotetraose).

A “sialylated oligosaccharide” is an oligosaccharide having a sialic acid residue with associated charge.

Suitable sialylated oligosaccharides include NeuAcα2,3Galβ1,4Glc and NeuAcα2,6Galβ1,4Glc.

A “fucosylated oligosaccharide” is an oligosaccharide having a fucose residue. It has a neutral nature. Some examples are 2-FL (2′-fucosyllactose), 3-FL (3-fucosyllactose), difucosyllactose, lacto-N-fucopentaose I, lacto-N-fucopentaose II, lacto-N-fucopentaose III, lacto-N-fucopentaose V, lacto-N-difucohexaose I, fucosyllacto-N-hexaose, Difucosyllacto-N-hexaose I, Difucosyllacto-N-neohexaose II.

Vitamin and mineral fortification may also be considered, in compliance with applicable food regulation for infant nutrition or young children nutrition.

In some embodiments, the beverage composition according to the invention contains from 10% to 30% total solids by weight. The total solids of the beverage composition are calculated as the weight of all dry matter from the ingredients per 100 g of composition. Thus, the dry matter from the milk component, the hydrolysed cereal component, the fermented milk component, and pectin are included in the total solids. The dry matter from other ingredients, if any, is also included in the total solids.

In some embodiments, the beverage composition of the present invention contains less than 4.0% by weight of fat, or about 2.0% by weight of fat. When using skim milk and fermented milk made from skim milk, it is possible to achieve a milk fat content as low as 0.1% by weight of the beverage composition. Vegetable fat and other lipids can be included to improve the nutritional value of the beverage composition. Overall, the fat content mainly derives from the milk component and the fermented milk component, as well as from vegetable fat and other lipids added. The amount of fat provided by the remaining components and ingredients of the beverage composition is usually negligible.

The beverage composition of the present invention is shelf-stable, meaning that its organoleptic and nutritional characteristics do not degrade noticeably over a period of several months, at ambient temperature. Usually, ambient temperature ranges from about 18° C. (at a consumer's home or in a shop) to about 45° C. (during transport or storage in a warehouse). It may be a temperature of from 20 to 30° C. for example.

Shelf-stability is commonly assessed by the expert in the industry according to various set of criteria. Shelf-stability includes biological, chemical and physical stability. If the beverage composition is not aseptically processed and filled under aseptic conditions, there can be microbiological contamination and spoilage, leading to degradation of the composition, with the potential presence and growth of pathogens over time. Usually, chemical stability is linked to oxidation and other chemical reactions that can occur between components of the beverage composition. The packaging is a barrier against oxygen and light, thereby limiting degradation of the beverage composition, and also acting as a barrier against physical, chemical and microbiological spoilage and contamination. Physical stability includes absence, or occurrence to only a limited extent, of physical phenomena such as demixing, creaming, serum formation, sedimentation or gel formation that would significantly affect the visual appearance, mouthfeel and texture of the beverage composition.

The shelf-stability may be checked during storage tests. Some of the main parameters to be assessed can be pH, viscosity, and sensory profile including visual appearance of the beverage composition. Some examples of methods to test shelf stability may be the following ones. Samples are stored at ambient temperatures, for example at 20° C. or at 30° C. (both conditions can be applied for the full duration of the storage tests). The samples are evaluated (monitoring of pH, viscosity and visual appearance) after one or more months, such as after 1, 3, 6, 9 and 12 months. By way of example, samples can also be evaluated at intervals of one month during the first 3 months, then after 6, 9 and 12 months of storage. Another example could be to evaluate the samples at intervals of one month during the first 3 months, then after 4, 5 and 9 months of storage.

The pH and viscosity may be measured according to analytical techniques commonly used by the skilled man. In one embodiment, a beverage composition that is shelf-stable means a composition having a ApH lower than 0.25 after 3, 6, 9 or 12 months at 20° C. or 30° C. The ApH may also be lower than 0.22, such as lower than 0.17, such as lower than 0.15, such as lower than 0.12, such as lower than 0.11 after 3, 6, 9 or 12 months at 20° C. or 30° C. In another embodiment, a beverage composition that is shelf-stable means a composition having a pH comprised between 4.6 and 5.1 after 3, 6, 9 or 12 months of storage at 20° C. or 30° C. The pH may also be between 4.7 and 5.0, such as between 4.8 and 5.0, after 3, 6, 9 or 12 months of storage at 20° C. or 30° C. In another embodiment, a beverage composition that is shelf-stable means a composition having a Aviscosity index lower than 0.15 after 3, 6, 9 or 12 months of storage at 20° C. or 30° C. The Aviscosity index may also be lower than 0.12, such as lower than 0.11 after 3, 6, 9 or 12 months of storage at 20° C. or 30° C. In another embodiment, a beverage composition that is shelf-stable means a composition having a viscosity index comprised between 0.85 and 1.15, such as between 0.9 and 1.1, after 3, 6, 9 or 12 months of storage at 20° C. or 30° C.

Sensory evaluation is performed by trained experts. In one embodiment, a beverage composition that is shelf-stable means a composition that remains homogenous in its visual appearance (i.e no detectable creaming, sedimentation or flocculation visible to the naked eye) after 3, 6, 9 or 12 months of storage at 20° C. or 30° C.

In particular, the beverage composition of the present invention is shelf-stable during 1, 3, 6, 9 or 12 months of storage at 20° C. or 30° C.

The pH of the beverage composition ranges from 4.6 to 5.1, advantageously from 4.8 to 5.0. The pH range of pH 4.8 to 5.0 is preferred for infants and young children, for organoleptic reasons. Indeed, a composition with too low pH, for instance at a pH usually found in yogurt (below pH 4.6), could be rejected by infants or young children due to the too acidic taste.

It came as a surprise to the inventors, to be able to prepare a beverage composition with a relatively high content in milk component and a relatively high content in fermented milk component, especially yogurt, that is stable against protein flocculation during processing (especially during heat-treatment) and storage, using a high-ester pectin at a pH as high as pH 5.1, exceeding the usual pH range of pectin functionality in acidified milk drinks.

The beverage composition according to the present invention is generally heat-treated to obtain a commercially sterile composition, for instance by UHT processing. Usually, the beverage composition is cooled before filling. The sterilised beverage composition is filled aseptically into appropriate containers. Aseptic filling can be performed according to standard procedures, using standard equipment. The containers can also be sterilised and filled with the beverage composition under a controlled sterile atmosphere. The filled containers may then be sealed under the controlled sterile atmosphere before leaving the filling equipment.

Various containers can be used, such as PE bottles, carton packs or Briks. The volume of the container can vary from one serving (from 100 mL to 250 mL) to 1 L. A single-serve container, containing one serving of beverage composition of the present invention, may be provided together with a drinking straw.

There is also provided a process for manufacturing a shelf-stable beverage composition according to the invention. The first step (step a) consists in providing a first liquid mix comprising a milk component and a hydrolysed cereal component. The milk component and the hydrolysed cereal component can be provided as a liquid composition or as a powder composition reconstituted into water, milk or fruit juice for instance. In an embodiment, the first liquid mix is provided at a temperature ranging from 2° C. to 14° C., or from 2° C. to 10° C. For instance, the milk component and the hydrolysed cereal component can be cooled separately to the desired temperature, then mixed together to obtain the first liquid mix. Alternatively, the milk component and the hydrolysed cereal component can be mixed at room temperature, or even at a higher temperature, to obtain the first liquid mix, which is then cooled to the desired temperature. In another alternative embodiment, milk powder can be mixed into the liquid hydrolysed cereal component, to obtain the first liquid mix, before, simultaneously or after cooling of the liquid. In yet another embodiment, the hydrolysed cereal component may be mixed as a powder into milk, which may already be cooled to the desired temperature.

During the first step, additional ingredients may be added to the first liquid mix. As standard procedure, vitamins and minerals may be added as a premix.

In an embodiment, a fruit component is incorporated in the first liquid mix. The fruit component has already been described above.

In the next step (step b), pectin is blended into the first liquid mix, while maintaining the blend at a temperature ranging from 2° C. to 14° C., or from 2° C. to 10° C. Preferably, pectin is high-ester pectin as described above. Pectin may be added as a powder or as a solution in water. In an embodiment, the pectin solution also contains sugar. Pectin is used to stabilise the final product. The addition of pectin into the first liquid mix provokes a first pH drop. For this reason, the first liquid mix should be maintained at a temperature below 14° C., advantageously below 10° C. to improve stability during manufacturing.

After addition of pectin into the first liquid mix, the next step (step c) is to incorporate a fermented milk component in the blend (i.e. the first liquid mix containing the added pectin), to obtain a second liquid mix. Incorporation of the fermented milk component also provokes a pH drop. Therefore, it is also advantageous to maintain the liquid mix at a temperature ranging from 2° C. to 14° C., or from 2° C. to 10° C. In some particular embodiments, the fermented milk component is added as a powder. For instance, the fermented milk component is yogurt powder.

Then, the pH of the second liquid mix is adjusted to a value ranging from pH 4.6 to 5.1, or to a value ranging from pH 4.8 to 5.0 (step d). In a particular embodiment, the pH is adjusted by addition of a food-grade acid, such as lactic acid, or citric acid. Lactic acid is advantageous because it is more acceptable from a taste perspective. As already mentioned, it is advantageous to maintain the temperature of the second liquid mix between 2° C. and 14° C. during preparation of the second liquid mix and also during pH adjustment, in particular at a temperature ranging from 2° C. to 10° C.

In a particular embodiment, the liquid mix is maintained at a temperature ranging from 2° C. to 10° C., at least during step b). In a particular embodiment, the liquid mix is also maintained at a temperature ranging from 2° C. to 10° C. during the subsequent steps c) and d). It should be noted that one or several of the steps b), c) and d) can be performed at a temperature ranging from 2° C. to 14° C. while the remaining steps among the steps b), c) and d) can be performed at a temperature ranging from 2° C. to 10° C.

In the next step (step e), the second liquid mix is heat-treated to obtain a shelf-stable beverage composition. The heat-treatment is a standard process, such as UHT treatment. In a particular embodiment, the heat-treated second liquid mix is aseptically filled into a container. Details have already been given above.

In a particular embodiment, the manufacturing process is performed batchwise.

### EXAMPLES

### Example 1

A yogurt drink with follow-on formula, cereals and peach was prepared according to the invention. The yogurt drink is shelf-stable at ambient temperature (e.g. at around 20° C. for 9 months) through UHT processing and aseptic filling in Briks (such as Combibloc Briks). The yogurt drink is ready-to-drink. It is adapted for consumption by infants from 6 months of age.

The yogurt drink contains a minimum of 50% by weight follow-on formula, 5.7% partially hydrolysed wheat flour (contributing about 26% by weight of the total solids), 2.7% low-fat yogurt powder, 1.2% peach purée (contributing about 0.15% to the total solids), and 0.3% pectin powder. The total solids target level of the yogurt drink is 18.7%. It is fortified with vitamins and minerals. The pH of the second liquid mix was adjusted using a lactic acid solution suitable for infant nutrition. The pH of the yogurt drink is about 4.9.

The nutritional profile of the yogurt drink is given in the Table 1.

TABLE 1
Nutritional profile of a yogurt drink according
to the invention containing peach purée.
Nutritional Profile

| | | | | | Per serving | |
|---|---|---|---|---|---|---|
| Nutrient | Per 100 g | | Per 100 mL | | of 200 mL | |
| Energy | 82 | kcal | 87 | kcal | 175 | kcal |
| | 347 | kJ | 369 | kJ | 738 | kJ |
| Protein | 2.6 | g | 2.8 | g | 5.5 | g |
| Carbohydrates, thereof | 13.2 | g | 14.0 | g | 28.1 | g |
| Sugars | 7.2 | g | 7.7 | g | 15.3 | g |
| Fat, thereof | 2.0 | g | 2.1 | g | 4.3 | g |
| Saturated Fatty Acids | 0.8 | g | 0.9 | g | 1.7 | g |
| Linoleic Acid | 0.30 | g | 0.32 | g | 0.64 | g |
| α-Linolenic Acid | 32 | mg | 34 | mg | 68 | mg |
| Total Dietary Fibres | 0.5 | g | 0.5 | g | 1.1 | g |
| Sodium | 0.03 | g | 0.03 | g | 0.06 | g |
| Calcium | 84 | mg | 89 | mg | 179 | mg |
| Magnesium | 16 | mg | 17 | mg | 34 | mg |
| Zinc | 0.8 | mg | 0.8 | mg | 1.6 | mg |
| Iron | 1.4 | mg | 1.5 | mg | 3.0 | mg |
| Iodine | 20 | mcg | 21 | mcg | 43 | mcg |
| Vitamin A | 115 | mcg | 122 | mcg | 245 | mcg |
| Vitamin D | 1.8 | mcg | 1.9 | mcg | 3.8 | mcg |
| Vitamin E | 0.9 | mg | 1.0 | mg | 1.9 | mg |
| Vitamin K | 5.6 | mcg | 6.0 | mcg | 11.9 | mcg |
| Vitamin C | 7 | mg | 7 | mg | 14 | mg |
| Vitamin B1 | 0.15 | mg | 0.16 | mg | 0.32 | mg |
| Vitamin B2 | 0.2 | mg | 0.2 | mg | 0.3 | mg |
| Niacin | 0.7 | mg | 0.7 | mg | 1.5 | mg |
| Vitamin B6 | 0.10 | mg | 0.11 | mg | 0.21 | mg |
| Folic Acid | 13 | mcg | 14 | mcg | 28 | mcg |
| Pantothenic Acid | 0.8 | mg | 0.9 | mg | 1.7 | mg |
| Vitamin B12 | 0.14 | mcg | 0.15 | mcg | 0.30 | mcg |
| Biotin | 3 | mcg | 3 | mcg | 6 | mcg |

### Example 2

A yogurt drink with follow-on formula, cereals and strawberry was prepared according to the invention. The yogurt drink is shelf-stable at ambient temperature (e.g. at around 20° C. for 9 months) through UHT processing and aseptic filling in Briks (such as Combibloc Briks). The yogurt drink is ready-to-drink. It is adapted for consumption by infants from 6 months of age.

The yogurt drink comprises a minimum of 50% by weight follow-on formula, 5.7% partially hydrolysed wheat flour (contributing about 26% by weight of the total solids), 2.7% low-fat yogurt powder, 1.0% strawberry purée (contributing about 0.09% to the total solids), and 0.3% high-ester pectin powder (GENU® pectin type JMJ supplied by CPKelco). The total solids target level of the yogurt drink is 18.6%. It is fortified with vitamins and minerals. The pH of the second liquid mix was adjusted using a lactic acid solution suitable for infant nutrition. The pH of the yogurt drink is about 4.9.

The nutritional profile of the yogurt drink is given in the Table 2.

### Example 3

A yogurt drink with follow-on formula, cereals and banana was prepared according to the invention. The yogurt drink is shelf-stable at ambient temperature (e.g.at around 20° C. for 9 months) through UHT processing and aseptic filling in Briks (such as Combibloc Briks). The yogurt drink is ready-to-drink. It is adapted for consumption by infants from 6 months of age.

The yogurt drink comprises a minimum of 50% by weight follow-on formula, 5.7% partially hydrolysed wheat flour (contributing about 26% by weight of the total solids), 2.7% low-fat yogurt powder, 7.0% banana purée (contributing about 1.61% to the total solids), and 0.3% high-ester pectin powder (GENU® pectin type JMJ supplied by CPKelco). The total solids target level of the yogurt drink is 18.7%. It is fortified with vitamins and minerals. The pH of the second liquid mix was adjusted using a lactic acid solution suitable for infant nutrition. The pH of the yogurt drink is about 4.9.

The nutritional profile of the yogurt drink is given in the Table 2.

TABLE 2
Nutritional profile of yogurt drinks according to the
invention containing strawberry (s) or banana (b) purée
Nutritional Profile of Strawberry (s) and Banana (b) Varieties

| | | | | | Per serving | |
|---|---|---|---|---|---|---|
| Nutrient | Per 100 g | | Per 100 mL | | of 200 mL | |
| Energy | 82 | kcal | 87 | kcal | 175 | kcal |
| | 347 | kJ | 369 | kJ | 738 | kJ |
| Protein | 2.6 | g | 2.8 | g | 5.5 | g |
| Carbohydrates, thereof | 13.2 | g | 14.0 | g | 28.1 | g |
| Sugars | 7.2 ^{(s)}/8.4 ^{(b)} | g | 7.7 ^{(s)}/8.9 ^{(b)} | g | 15.3 ^{(s)}/17.9 ^{(b)} | g |
| Fat, thereof | 2.0 | g | 2.1 | g | 4.3 | g |
| Saturated Fatty Acids | 0.8 | g | 0.9 | g | 1.7 | g |
| Linoleic Acid | 0.30 | g | 0.32 | g | 0.64 | g |
| α-Linolenic Acid | 32 ^{(s)}/34 ^{(b)} | mg | 34 ^{(s)}/36 ^{(b)} | mg | 68 ^{(s)}/72 ^{(b)} | mg |
| Total Dietary Fibres | 0.5 | g | 0.5 | g | 1.1 | g |
| Sodium | 0.03 | g | 0.03 | g | 0.06 | g |
| Calcium | 84 ^{(s)}/81 ^{(b)} | mg | 89 ^{(s)}/86 ^{(b)} | mg | 179 ^{(s)}/172 ^{(b)} | mg |
| Magnesium | 16 ^{(s)}/15 ^{(b)} | mg | 17 ^{(s)}/16 ^{(b)} | mg | 34 ^{(s)}/32 ^{(b)} | mg |
| Zinc | 0.8 | mg | 0.8 | mg | 1.6 | mg |
| Iron | 1.4 | mg | 1.5 | mg | 3.0 | mg |
| Iodine | 20 | mcg | 21 | mcg | 43 | mcg |
| Vitamin A | 115 ^{(s)}/100 ^{(b)} | mcg | 122 ^{(s)}/106 ^{(b)} | mcg | 245 ^{(s)}/213 ^{(b)} | mcg |
| Vitamin D | 1.8 ^{(s)}/1.7 ^{(b)} | mcg | 1.9 ^{(s)}/1.8 ^{(b)} | mcg | 3.8 ^{(s)}/3.6 ^{(b)} | mcg |
| Vitamin E | 0.9 ^{(s)}/0.7 ^{(b)} | mg | 1.0 ^{(s)}/0.7 ^{(b)} | mg | 1.9 ^{(s)}/1.5 ^{(b)} | mg |
| Vitamin K | 5.6 | mcg | 6.0 | mcg | 11.9 | mcg |
| Vitamin C | 7 | mg | 7 | mg | 14 | mg |
| Vitamin B1 | 0.15 | mg | 0.16 | mg | 0.32 | mg |
| Vitamin B2 | 0.20 ^{(s)}/0.14 ^{(b)} | mg | 0.21 ^{(s)}/0.15 ^{(b)} | mg | 0.43 ^{(s)}/0.30 ^{(b)} | mg |
| Niacin | 0.7 | mg | 0.7 | mg | 1.5 | mg |
| Vitamin B6 | 0.10 | mg | 0.11 | mg | 0.21 | mg |
| Folic Acid | 13 ^{(s)}/15 ^{(b)} | mcg | 14 ^{(s)}/16 ^{(b)} | mcg | 28 ^{(s)}/32 ^{(b)} | mcg |
| Pantothenic Acid | 0.8 | mg | 0.9 | mg | 1.7 | mg |
| Vitamin B12 | 0.14 ^{(s)}/0.13 ^{(b)} | mcg | 0.15 ^{(s)}/0.14 ^{(b)} | mcg | 0.30 ^{(s)}/0.28 ^{(b)} | mcg |
| Biotin | 3.0 ^{(s)}/2.9 ^{(b)} | mcg | 3.2 ^{(s)}/3.1 ^{(b)} | mcg | 6.4 ^{(s)}/6.2 ^{(b)} | mcg |

Values valid for both varieties unless otherwise specified (indices ‘s’ and ‘b’)

### Example 4

For all examples described above, individual batches were produced on industrial scale and storage tests were performed to assess the shelf-stability of these beverage compositions.

Two batches were produced for each variety of the yogurt drinks as described in examples 3. and 2; one batch was produced of the yogurt drink as described in the example 3. The storage test samples were evaluated at defined time intervals after storage at ambient temperature (either at 20° C. or at 30° C.) by visual inspection by a panel of trained experts, and by measure of the pH and viscosity index.

All these measurements of the samples were performed at room temperature (20° C.).

Measurement of pH was performed using pH meter SevenCompact S220 equipped with electrode InLab®Expert Pro-ISM with integrated temperature probe (Mettler Toledo, Switzerland). Measurements were made at room temperature (20° C.), and after 30 days (1 month), 90 days (3 months), 180 days (6 months), 270 days (9 months) and 360 days (12 months) of storage at ambient temperature (20° C. and 30° C.) for the yogurt drinks of examples 1 and 2, or after 30 days (1 month), 60 days (2 months), 90 days (3 months), 120 days (4 months), 150 days (5 months), 180 days (6 months), and 270 days (9 months) of storage at ambient temperature (20° C. and 30° C.) for the yogurt drink of example 3.

Product viscosity was determined according to established methods in the art, based on the time needed for a fluid to run over a defined distance under the influence of gravity. The viscosity was determined as the time needed for a fixed amount of sample to flow through a calibrated nozzle, the characteristic time measured being directly related to viscosity. The characteristic time values determined as a measure of product viscosity at the different time points during the storage tests were normalised (i.e divided) by the initial values determined in samples after 1 month of storage (time that was needed for product texture to fully develop) and are referred to as “viscosity index”. A significant increase in viscosity index would witness thickening of the products, whereas a decrease in viscosity index would witness thinning of the products. As an example, a viscosity index of 2 would mean that the time needed for the sample to flow through the nozzle will be doubled. Measurements were made at room temperature (20° C.), and after 30, 90, 180, 270 and 360 days of storage at ambient temperature (20° C. and 30° C.) for the yogurt drinks of examples 1 and 2, or after 30, 60, 90, 120, 150, 180, and 270 days of storage at ambient temperature (20° C. and 30° C.) for the yogurt drink of example 3.

Visual inspection revealed absence of creaming and sedimentation, and a liquid and smooth texture in all samples evaluated.

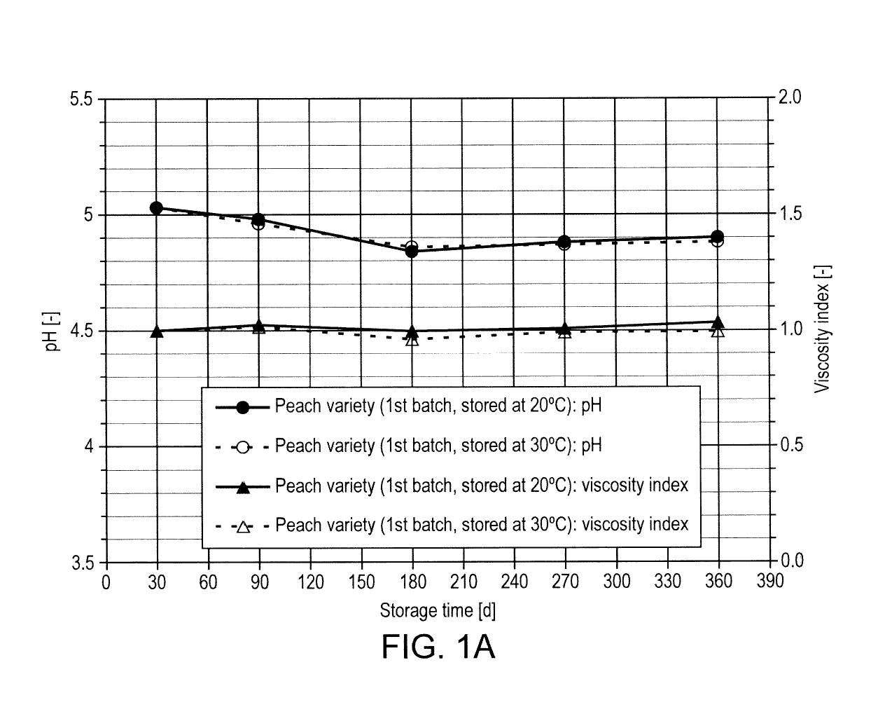

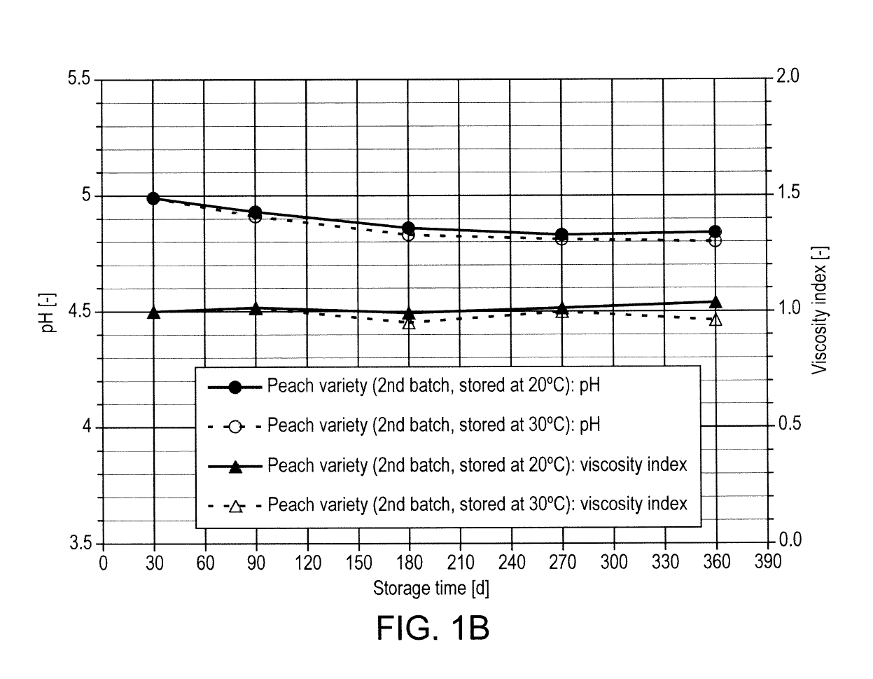

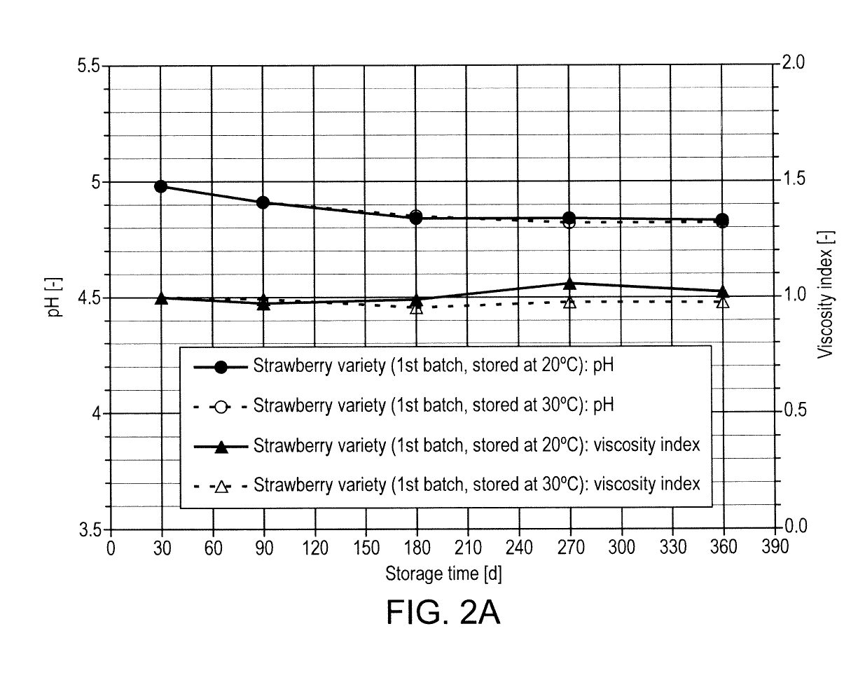

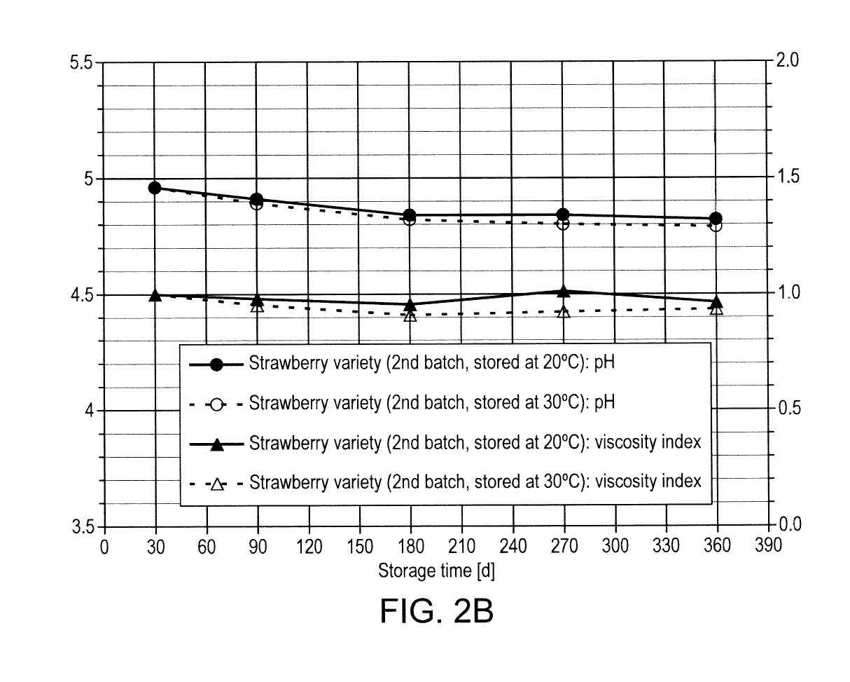

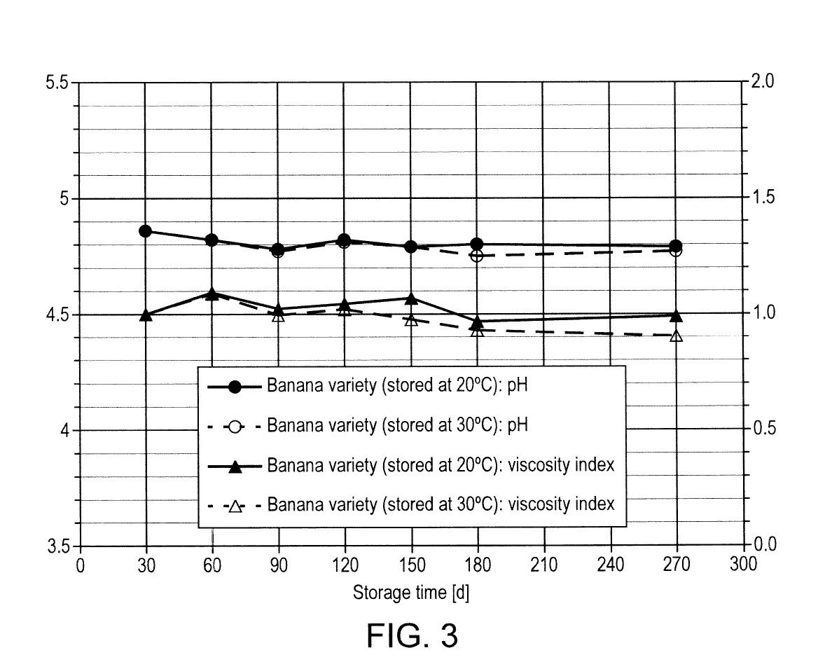

As described in FIG. 1, FIG. 2 and FIG. 3, the pH of the samples remained comprised between pH 4.6 to 5.1 and the ApH was lower than 0.25 after 3, 6, 9 (FIGS. 1, 2 and 3) and after 12 months (FIGS. 1 and 2) of storage at ambient temperature (20° C. and 30° C.). These results indicate that the yogurt drinks of the present invention are shelf-stable.

As described in FIG. 1, FIG. 2 and FIG. 3, the viscosity index of the samples remained comprised between 0.85 and 1.15 and the Aviscosity index was lower than 0.15 after 3, 6, 9 (FIGS. 1, 2 and 3) and 12 months (FIGS. 1 and 2) of storage at ambient temperature (20° C. and 30° C.). These results indicate that the yogurt drinks of the present invention are shelf-stable.

Although particular embodiments have been disclosed in the description with reference to specific examples, it will be recognised that the invention is not limited to the particular embodiments. Various modifications may become apparent to those of ordinary skill in the art and may be acquired from practice of the invention. It will be understood that the materials used and the chemical details may be slightly different or modified from the descriptions without departing from the methods and compositions disclosed and taught by the present invention.

1. A beverage composition comprising a milk component, a hydrolysed cereal component, a fermented milk component, and added pectin, wherein the pH of the beverage composition ranges from pH 4.6 to 5.1, and the beverage composition is shelf-stable.

2. A beverage composition according to claim 1, wherein the pH of the beverage composition ranges from pH 4.8 to 5.0.

3. A beverage composition according to claim 1, which is suitable for infants, or for young children, or for infants and young children.

4. A beverage composition according to claim 1, wherein the milk component is selected from the group consisting of skim milk, semi-skim milk, full-fat milk, follow-on formula, and growing-up milk.

5. A beverage composition according to claim 1, wherein the hydrolysed cereal component represents from 10% to 65% by weight of the total solids of the composition.

6. A beverage composition according to claim 1, wherein the fermented milk component represents the equivalent of from 5 g to 90 g of fresh fermented milk per 100 g of composition.

7. A beverage composition according to claim 1, wherein the fermented milk component is yogurt.

8. A beverage composition according to claim 1, wherein the pectin is high-ester pectin.

9. A beverage composition according to claim 1, which contains from 10% to 30% total solids by weight.

10. A beverage composition according to claim 1, which contains less than 4.0% by weight of fat.

11. A beverage composition according to claim 1, further comprising at least one additional ingredient selected from the group consisting of fruit components, sweeteners, starches, flavours, prebiotics, vitamins, minerals, and any combination thereof

12. A process for manufacturing a shelf-stable beverage composition, the process comprising the steps of:
a) providing a first liquid mix comprising a milk component and a hydrolysed cereal component;
b) blending pectin into the first liquid mix, and maintaining the blend at a temperature ranging from 2° C. to 14° C., then;
c) incorporating a fermented milk component into the blend from step b), to obtain a second liquid mix;
d) adjusting the pH of the second liquid mix to a value ranging from pH 4.6 to 5.1; and
e) heat-treating the second liquid mix to obtain a shelf-stable beverage composition.

13. A process according to claim 12, wherein some additional ingredients are added at any step prior step e).

14. A process according to claim 12, wherein the blend from step b) is maintained at a temperature ranging from 2° C. to 14° C. during step c).

15. A process according to claim 12, wherein the second liquid mix is maintained at a temperature ranging from 2° C. to 14° C. during step d).

16. A process according to claim 12, wherein the temperature of the liquid mix is maintained between 2° C. and 10° C. at least during step b).

17. A process according to claim 12, wherein the heat-treated second liquid mix is aseptically filled into a container.
